(19) United States
(12) Patent Application Publication
(10) Pub. No.: US 2023/0273770 A1
(43) Pub. Date: Aug. 31, 2023

(54) Iterative Multiplicative Reduction Circuit

(71) Applicant: Intel Corporation, Santa Clara, CA (US)

(72) Inventors: Sergey Vladimirovich Gribok, Santa Clara, CA (US); Martin Langhammer, Alderbury (GB); Bogdan Pasca, Toulouse (FR)

(21) Appl. No.: 18/122,656

(22) Filed: Mar. 16, 2023

Related U.S. Application Data
(60) Provisional application No. 63/409,201, filed on Sep. 22, 2022.

(51) Int. Cl. G06F 7/523; G06F 7/72

(52) U.S. Cl. CPC G06F 7/523; G06F 7/72

(57) ABSTRACT

Integrated circuit devices, methods, and circuitry for implementing and using an iterative multiplicative modular reduction circuit are provided. Such circuitry may include polynomial multiplication circuitry and modular reduction circuitry that may operate concurrently. The polynomial multiplication circuitry may multiply a first input value to a second input value to compute a product. The modular reduction circuitry may perform modular reduction on a first component of the product while the polynomial multiplication circuitry is still generating other components of the product.

### CROSS-REFERENCE TO RELATED APPLICATIONS

This application claims priority to U.S. Provisional Application No. 63/409,201 filed Sep. 22, 2022, titled “INTEGRATED CIRCUIT ARCHITECTURE FOR A CRYPTOGRAPHIC PUZZLE SOLVER,” which is incorporated herein by reference in its entirety for all purposes.

### BACKGROUND

This disclosure relates to area-efficient circuitry of an integrated circuit to perform iterative modular multiplication.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include arithmetic circuit blocks to perform arithmetic operations such as addition and multiplication. For example, a digital signal processing (DSP) block may supplement programmable logic circuitry in a programmable logic device, such as a field programmable gate array (FPGA). Programmable logic circuitry and DSP blocks may be used to perform numerous different arithmetic functions.

As cryptographic and blockchain applications become increasingly prevalent, integrated circuits are increasingly used to compute very large combinatorial functions. Verifiable delay functions (VDFs), for example, are used in blockchain and cryptocurrency operations. Cryptographic puzzles, such as the CSAIL2019, also involve solving large number of intrinsically sequential computations - computations that cannot be parallelized - with each iteration performing a very large arithmetic operation. Existing VDFs are too slow in central processing units (CPUs). And application-specific integrated circuits (ASICs) cannot readily keep up with the rapidly changing VDF specifications for various blockchain and cryptocurrency applications. Yet FPGA solutions, while flexible, are very logic-intensive in a way that introduces timing closure problems and are very power hungry.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of the integrated circuit device of FIG. 1;

FIG. 3 is a block diagram of an integer polynomial that may be used in modular multiplication on the integrated circuit device;

FIG. 4 is a block diagram of an example of modular multiplication of an integer polynomial where both the multiplication and reduction stages are performed in parallel, facilitated by multiplying from least significant word to most significant word;

FIG. 5 is a block diagram of an example of polynomial multiplication portion of the modular multiplication of FIG. 4;

FIG. 6 is a block diagram of an example of a modular reduction portion of the modular multiplication of FIG. 4;

FIG. 7 is a block diagram of another example of a modular reduction portion of the modular multiplication of FIG. 4;

FIG. 8 is a block diagram of an example of modular multiplication of an integer polynomial performed on the integrated circuit device where the modular reduction is performed iteratively from most significant word to least significant word;

FIG. 9 is a block diagram of an iterative modular multiplier circuit that can carry out the modular multiplication of FIG. 8;

FIG. 10 is a block diagram of an example of a modular reduction portion of the modular multiplication of FIG. 8;

FIG. 11 is a flowchart of a method for performing error checking of intermediate results of an iterative multiplicative reduction circuit;

FIG. 12A is a block diagram illustrating directed pipelining that may enhance the efficiency of the iterative modular multiplier circuit of FIG. 9;

FIG. 12B is a block diagram illustrating directed pipelining with inner loops that may enhance the efficiency of the iterative modular multiplier circuit of FIG. 9;

FIG. 12C is a block diagram illustrating directed pipelining with a pipelined loop with inner loops that may enhance the efficiency of the iterative modular multiplier circuit of FIG. 9;

FIG. 13 is a timing diagram comparing the total latency of two pipelining approaches;

FIG. 14 is a block diagram of a pipelined example of the iterative modular multiplier circuit of FIG. 9;

FIG. 15 is an example floorplan of the iterative modular multiplier circuit implemented on an FPGA as a cryptographic puzzle solver; and

FIG. 16 is a block diagram of a data processing system that may incorporate the integrated circuit.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Verifiable delay functions (VDFs) have gained widespread use in cryptocurrency and blockchain applications. Many VDFs employ modular multiplication operations. Polynomial modular multiplication involves two parts - multiplication and modular reduction, sometimes also referred to as multiplicative expansion and division reduction. This disclosure describes a circuit that can calculate modular multiplication of any suitable precision (e.g., even many thousands of bits) using a multi-cycle implementation. This may allow any size of this type of operation to be implemented in a field-programmable gate array (FPGA). As such, it may outperform other processors such as central processing units (CPUs) and graphics processing units (GPUs) by many orders of magnitude. It is several times more arithmetically efficient (e.g., with respect to a number of operations per normalized precision squared) and about 10x as power efficient as any other FPGA solution presently known.

This solution benefits from many innovations, including:
1. A left to right restating of a modular multiplication - this allows the multiplicative expansion portion and the division reduction to run simultaneously, rather than one after each other. This double the throughput over any other method, even if a way is found to make other methods multi-cycle.
2. Overclocking this circuit and using intermediate error checking — the intermediate error checking uses aspects from number theory to detect errors in the running calculation. This is valuable because many calculations can take billions of iterations. If the circuit is overclocked by 10%, for example, this is significant because the commercial application is a speed contest. (First to finish wins.)
3. A multi-level clocking scheme that allows this much-larger-than-typical design to outperform smaller direct implementations.

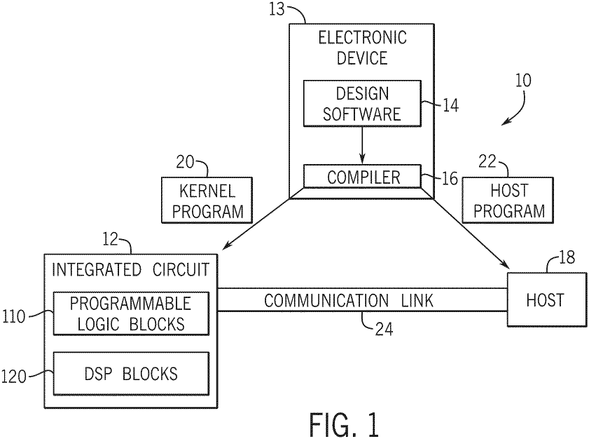

Thus, the iterative multiplicative reduction circuit of this disclosure may provide more flexibility, higher performance, and lower power. The flexibility of the circuit may allow it to scale to any suitable future value or size of the modulus. Higher performance is also gained — several times more arithmetically dense than any known algorithm. Lower power consumption is also achieved, reaching about 10x lower power compared to the next fastest method. FIG. 1 illustrates a block diagram of a system 10 that may be used to implement the iterative modular multiplication of this disclosure on an integrated circuit system 12 (e.g., a single monolithic integrated circuit or a multi-die system of integrated circuits). A designer may desire to implement iterative modular multiplication on the integrated circuit system 12 (e.g., a programmable logic device such as a field-programmable gate array (FPGA) or an application-specific integrated circuit (ASIC) that includes programmable logic circuitry). The integrated circuit system 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit system 12.

In a configuration mode of the integrated circuit system 12, a designer may use an electronic device 13 (e.g., a computer) to implement high-level designs (e.g., a system user design) using design software 14, such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit system 12. The host 18 may receive a host program 22 that may control or be implemented by the kernel programs 20. To implement the host program 22, the host 18 may communicate instructions from the host program 22 to the integrated circuit system 12 via a communications link 24 that may include, for example, direct memory access (DMA) communications or peripheral component interconnect express (PCIe) communications. In some embodiments, the kernel programs 20 and the host 18 may configure programmable logic blocks 110 on the integrated circuit system 12. The programmable logic blocks 110 may include circuitry and/or other logic elements and may be configurable to implement a variety of functions in combination with digital signal processing (DSP) blocks 120.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

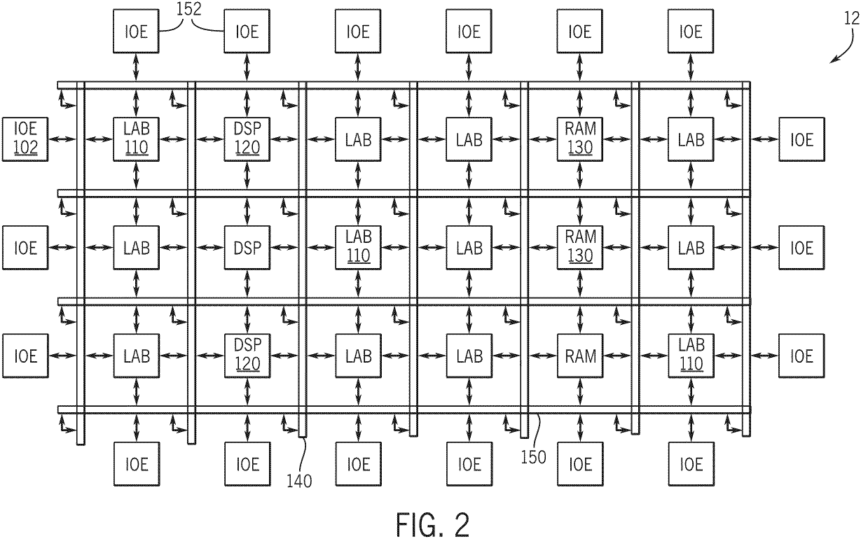

An illustrative embodiment of a programmable integrated circuit system 12 such as a programmable logic device (PLD) that may be configured to implement a circuit design is shown in FIG. 2. As shown in FIG. 2, the integrated circuit system 12 (e.g., a field-programmable gate array integrated circuit) may include a two-dimensional array of functional blocks, including programmable logic blocks 110 (also referred to as logic array blocks (LABs) or configurable logic blocks (CLBs)) and other functional blocks, such as embedded digital signal processing (DSP) blocks 120 and embedded random-access memory (RAM) blocks 130, for example. Functional blocks such as LABs 110 may include smaller programmable regions (e.g., logic elements, configurable logic blocks, or adaptive logic modules) that receive input signals and perform custom functions on the input signals to produce output signals. LABs 110 may also be grouped into larger programmable regions sometimes referred to as logic sectors that are individually managed and configured by corresponding logic sector managers. The grouping of the programmable logic resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy.

Programmable logic the integrated circuit system 12 may contain programmable memory elements. Memory elements may be loaded with configuration data (also called programming data or configuration bitstream) using input-output elements (IOEs) 102. Once loaded, the memory elements each provide a corresponding static control signal that controls the operation of an associated functional block (e.g., LABs 110, DSP 120, RAM 130, or input-output elements 102).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements. Programmable logic device (PLD) 100 may be configured to implement a custom circuit design. For example, the configuration RAM may be programmed such that LABs 110, DSP 120, and RAM 130, programmable interconnect circuitry (i.e., vertical channels 140 and horizontal channels 150), and the input-output elements 102 form the circuit design implementation.

In addition, the programmable logic device may have input-output elements (IOEs) 102 for driving signals off the integrated circuit system 12 and for receiving signals from other devices. Input-output elements 102 may include parallel input-output circuitry, serial data transceiver circuitry, differential receiver and transmitter circuitry, or other circuitry used to connect one integrated circuit to another integrated circuit.

The integrated circuit system 12 may also include programmable interconnect circuitry in the form of vertical routing channels 140 (i.e., interconnects formed along a vertical axis of the integrated circuit 100) and horizontal routing channels 150 (i.e., interconnects formed along a horizontal axis of the integrated circuit 100), each routing channel including at least one track to route at least one wire. If desired, the interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 1, are intended to be included within the scope of the present invention. For example, the routing topology may include wires that travel diagonally or that travel horizontally and vertically along different parts of their extent as well as wires that are perpendicular to the device plane in the case of three-dimensional integrated circuits, and the driver of a wire may be located at a different point than one end of a wire. The routing topology may include global wires that span substantially all of the integrated circuit system 12, fractional global wires such as wires that span part of the integrated circuit system 12, staggered wires of a particular length, smaller local wires, or any other suitable interconnection resource arrangement.

The integrated circuit system 12 may be programmed to perform a wide variety of operations, including the iterative modular multiplication of this disclosure. As mentioned above, the iterative modular multiplication has a wide variety of uses, including many relating to cryptography, cryptocurrency, and blockchain applications. One example use case is as a solver of a crypto-puzzle known as CSAIL2019. Since this is a particularly challenging crypto-puzzle, this disclosure will describe many ways in which the iterative modular multiplication of this disclosure may be used to work to solve the CSAIL2019 puzzle. Indeed, since the iterative modular multiplication of this disclosure provides a dramatic step toward solving the CSAIL2019 puzzle, the iterative modular multiplication of this disclosure is well suited for numerous other commercial cryptography, cryptocurrency, and blockchain applications.

### CSAIL2019 Problem Statement

The cryptographic puzzle is specified as the compute of 2^{2^{t}} (mod N ), where t = 2⁵⁶ = 72057594037927936, and N = 3072 bits.

N=4748097547272012866175034130616773885051260744920056444867106196360710424558147654252707604941012311775892012567579064620536874633385055919001167621577710311366072057029421705135684303934811390137937802096433163959216892351184826691180016055198866796536230085523200683549066995672155839042282955591568494603061113292039044753843846484807112228389204239581712931108919820250218586352043897306238872025378193141111507426311444613498736315614218304761735541626997839036517728000688394015610618179768868342070395100147620295616695834440894241147905565567808298149024668527045239650145862092904119412874007763041042314287604772876861294417664020832796209135587181826458235580003825823724235800850160284850809737200983703552179354691863876044443377822439834079313578029085658078575731290244778595615229472411326831502667425768520006371752963274296294506063182258064362048788338392528266351511304921847854750642192694541125065873977.

While the full puzzle requires a solution for t = 2⁵⁶, CSAIL is also interested in solutions for t = 2^{k} for 56/2

$$⩽$$

k < 56. These intermediate solutions are called “milestone versions of the puzzle”. The iterative modular multiplication circuit of this disclosure has been tested and shown to be remarkably effective, reaching 21 milestone solutions in just the first six months of operation.

### FPGA Modular Multiplication Methods

Before describing the iterative modular multiplication circuit of this disclosure, a method known as the Ozturk method will be discussed briefly. While the Ozturk method of modular multiplication may work well in some circumstances, it may be ineffective under certain conditions, such as when the method is used with large word sizes (e.g., greater than 1024-bit word size). As will be discussed in the next section, there are a number of ways to manage this. First, this disclosure will explore high performance multi-cycle approaches, which may fit into FPGAs more readily. Secondly, this disclosure will describe more efficient ways of implementing the Ozturk algorithm. Indeed, DSP blocks are intrinsically more efficient than soft logic, as the functionality is already in ASIC form. This gives us a strong basis for restating the Ozturk approach from a table-based to arithmetic-based reduction operation. This section will briefly review the Ozturk approach and the next section will describe the iterative modular multiplication of this disclosure that uses the embedded FPGA DSP resources for a more efficient and higher performance result. The DSP-based approach of the iterative modular multiplication of this disclosure may be further implemented as an efficient multi-cycle version.

### A. Integer Multiplication

The large integer multiplication is implemented as a polynomial multiplication. The inputs A and B are unsigned integers represented in polynomial form as d + 1 radix R = 2^{w}⁺¹ digits. Note that there is a one bit overlap between consecutive digits.

$$A = {\sum }_{i = 0}^{d} {A}_{i} {2}^{w i} \qquad \text{(1)}$$

$$B = {\sum }_{i = 0}^{d} {B}_{i} {2}^{w i} \qquad \text{(2)}$$

From the radix-R digit notation, the polynomial notation (x = 2^w) follows:

$$A \left(x\right) = {\sum }_{i = 0}^{d} {A}_{i} {x}^{i} \qquad \text{(3)}$$

$$B \left(x\right) = {\sum }_{i = 0}^{d} {B}_{i} {x}^{i} \qquad \text{(4)}$$

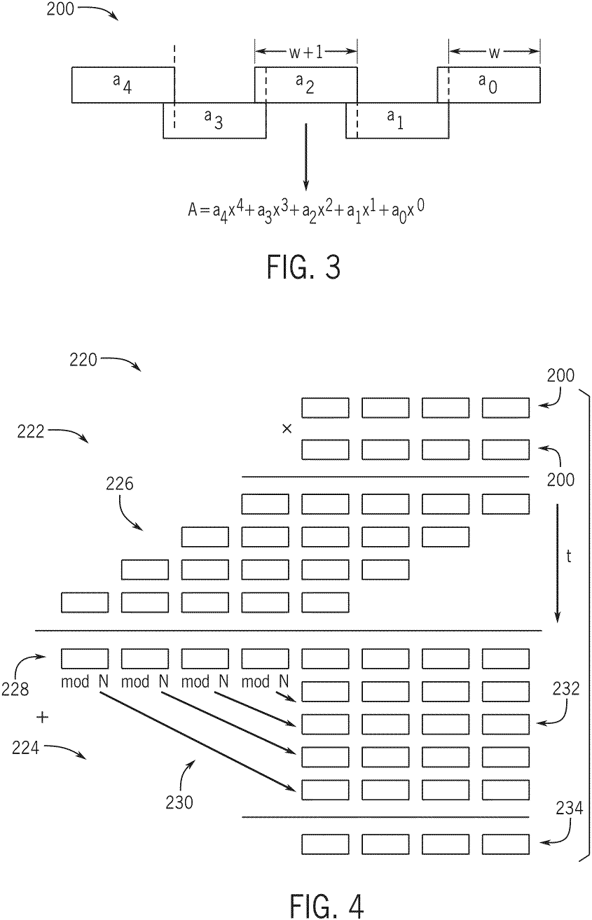

Here Aᵢ, Bᵢ are the coefficients of the polynomials, and correspond to the radix-R digits from the original representation. This is highlighted in FIG. 3, which is a schematic diagram of an integer (e.g., one of A or B) viewed as a degree-d polynomial 200.

The product P of two degree d polynomials A and B is a degree 2d polynomial, which may undergo modular reduction to reduce back to a degree d polynomial. FIG. 4 provides a schematic overview of Ozturk modular multiplication 220, involving polynomial multiplication 222 and modular reduction 224. In the polynomial multiplication 222, two polynomials 200 may be multiplied together to obtain partial products 226. The partial products 226 are obtained by multiplication from least significant words to most significant words (e.g., conventionally right-to-left) over time t (also understood to be an order of the operation). The partial products 226 are split at 2^w boundaries before being added together to obtain a product 228. After the product 228 is obtained, modular reduction 224 may begin, in which a modulo N operation 230 is applied to respective words of degree d+1 to 2d of the product P and the results 232 are added to the least significant words of the product P. A resulting modular reduction 234 has degree d.

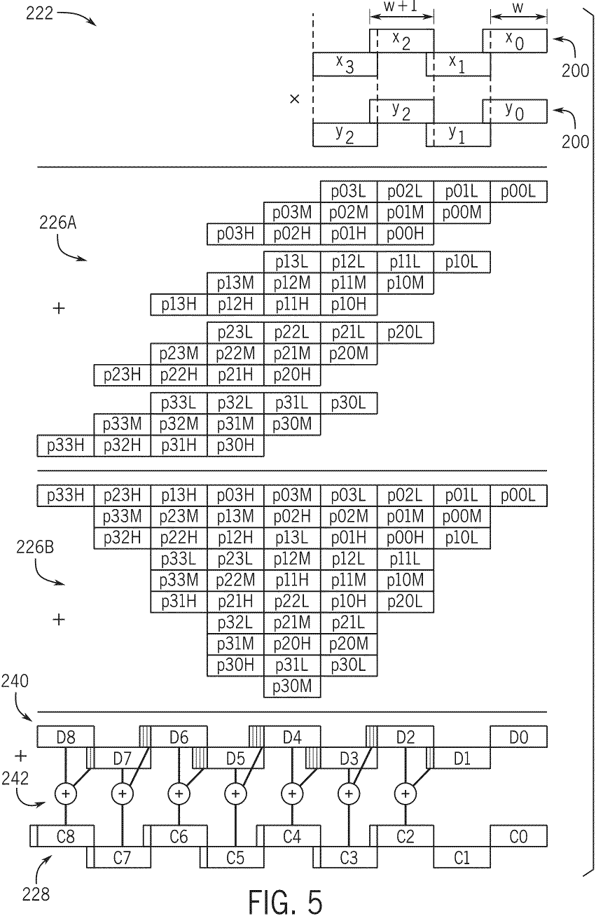

FIG. 5 provides an example of the partial products of polynomial multiplication 222 for polynomials 200 of degree d = 3. The subproducts AᵢBⱼ are 2w+2-bit wide values, and can be written in terms of two w-bit values and a 2-bit value:

$${A}_{i} {B}_{j} = {P}_{i j} = {P}_{i j}^{H} {2}^{2 w} + {P}_{i j}^{M} {2}^{w} + {P}_{i , j}^{L} \qquad \text{(5)}$$

Knowing that x=2^w, the subproduct alignments are such that: the middle part

$${P}_{i , j}^{M}$$

overlaps over

$${P}_{k , l}^{L}$$

where k + l = i + j + 1, and the high part

$${P}_{i , j}^{H}$$

overlaps over

$${P}_{k , l}^{L}$$

where k + l = i + j + 2.

These alignments can be observed in FIG. 5. FIG. 5 is a schematic diagram of subproduct 226 alignments for a degree-3 polynomial multiplication corresponding to 4-digit radix R inputs. Subproducts 226A and 226B are equivalent arrangements of the same values. The columns of subproduct sections aligned at weights 2^{wi} correspond to non-evaluated sums 240 that, when evaluated through addition 242, correspond to coefficients of the output polynomial product 228. Therefore, each column of the subproducts 226B may be summed together (e.g., columns have between 1 and 9 subproduct components), to generate intermediary coefficients Dᵢ, with widths ranging from w bits (for D₀) to w+4 bits (for D₄).

A set of w-bit wide additions aligned on the column output sums 240 may be performed, creating modified polynomial coefficients 228 such that their maximum widths do not exceed w+1. This is accomplished by a level of short adders 242 that sum the lower w bits of Dᵢ (Dᵢ mod 2^{w}) with the bits having weights larger than 2^{w} from Dᵢ₋₁ (Dᵢ₋₁ » w). This propagation may only be implemented for i

$$⩾$$

2, as for i = 0 does not produce any carry-out.

$${D}_{k} = {\sum }_{i + j + 2 = k} {P}_{i , j}^{H} + {\sum }_{i + j + 1 = k} {P}_{i , j}^{M} + {\sum }_{i + j = k} {P}_{i , j}^{L} \qquad \text{(6)}$$

$${D}_{k} = \left({D}_{i} mod {2}^{w}\right) + \left({D}_{i - 1} ≫ w\right) , i ∈ \left[2 , 2 d + 1\right] \qquad \text{(7)}$$

This level of adders 242 is depicted on the bottom of FIG. 5.

The product P 228 can be written in polynomial form:

$$P = {\sum }_{i = 0}^{2 d + 1} {C}_{i} {x}^{i} \qquad \text{(8)}$$

with Cᵢ holding on 2^{w+1} bits.

### B. Modular Reduction

The second part of the modular multiplication 220 is modular reduction 224, which involves reducing the product P 228 (e.g., the polynomial output previously generated) by mod N.

$$M = P mod N \qquad \text{(9)}$$

In the context of modular exponentiation, an exact (e.g., non-reducible) M may not necessarily be required, but rather any equivalent M is sufficient, as long as it meets a number of properties. One of these is that it be sufficiently easy to obtain, another is that the output have the same form as the input of the polynomial multiplication inputs 200.

The following property is used for obtaining M:

$$\begin{matrix}A + B mod N ≡ \left(\left(A mod N\right) + \left(B mod N\right)\right) m o d N ≡ \\ \left(\left(A mod N\right) + B\right) mod N\end{matrix} \qquad \text{(10)}$$

We split P in two parts:

$$P = {\sum }_{i = d + 1}^{2 d + 1} {C}_{i} {x}^{i} + {\sum }_{i = 0}^{d} {C}_{i} {x}^{i} \qquad \text{(11)}$$

Next, the high part is composed of d + 1 radix 2^(w+1) digits. For each digit, the reduced value mod N is tabulated:

$${M}_{i} = {C}_{i} {x}^{i} mod N , i ∈ \left[d + 1 , 2 d + 1\right] \qquad \text{(12)}$$

Additionally, each Mᵢ can be viewed as a degree-d polynomial, with coefficients M_{i,j} radix 2^{w} digits. This allows for the following rewrite:

$$M = {\sum }_{i = 0}^{d} \left({C}_{i} + {\sum }_{j = d + 1}^{2 d + 1} {M}_{j , i}\right) {x}^{i} mod N \qquad \text{(13)}$$

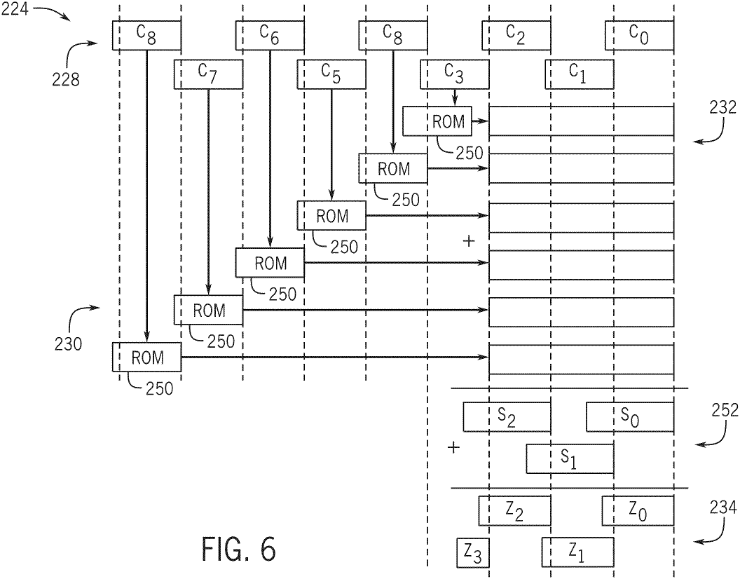

This results again in column-based summations, as shown in FIG. 6. In FIG. 6, the modulo N operation 230 of the modular reduction 224 is performed using lookup tables stored in memory, shown in FIG. 6 as read-only memories (ROMs) 250. The results 232 of the modulo N operation 230 are added to obtain intermediate results 252 that may have widths greater than w or w+1. A final reduction, similar to the case of the multiplier, is performed in order to obtain w+1-bit wide coefficients for the output polynomial (modular reduction 234). This is shown on the bottom of FIG. 6, resulting in a d + 1-degree polynomial.

Note that the output is still in redundant form, and a full width addition (which would be expensive in both area and latency) may be required in order to return the output in standard form. But this may not matter when w + 1 is chosen to be the same width as the multiplier for each polynomial element (e.g., match 27-bit multipliers found in the DSP blocks 120). The columns of the next iteration are still w bits wide, and any additional word-growth of each column because the coefficients are w +1 instead of w bits wide are contained by the column width (e.g., w bit) additions at the end of the iteration. Hence, the maximum coefficient size will always remain at w bits.

### C. Multiplicative Reduction

While the method of FIG. 6 is a significant improvement over previous methods, and makes much higher performance modular multiplication possible in FPGAs, it also exposes a significant weakness in the FPGA context. As the partial reduction values M are stored in LUTs (ROMs 250), the amount of logic used to store the tables can be very large. But the logic area is not the only issue. The partial moduli may be summed with the result of the multiplicative expansion, and the outputs from the tables may be individually routed to the adder trees; that is, unlike in many designs, the outputs of the tables may not be combined locally with logic (e.g., LABs or CLBs) where a short wire could be used. As the word size of the Ozturk multiplier increases, place and route may become an increasingly difficult problem.

Equation (13) may be rewritten as:

$${M}_{i} = {C}_{i} ⋅ \left({x}^{i} mod N\right) , i ∈ \left[d + 1 , 2 d + 1\right] \qquad \text{(14)}$$

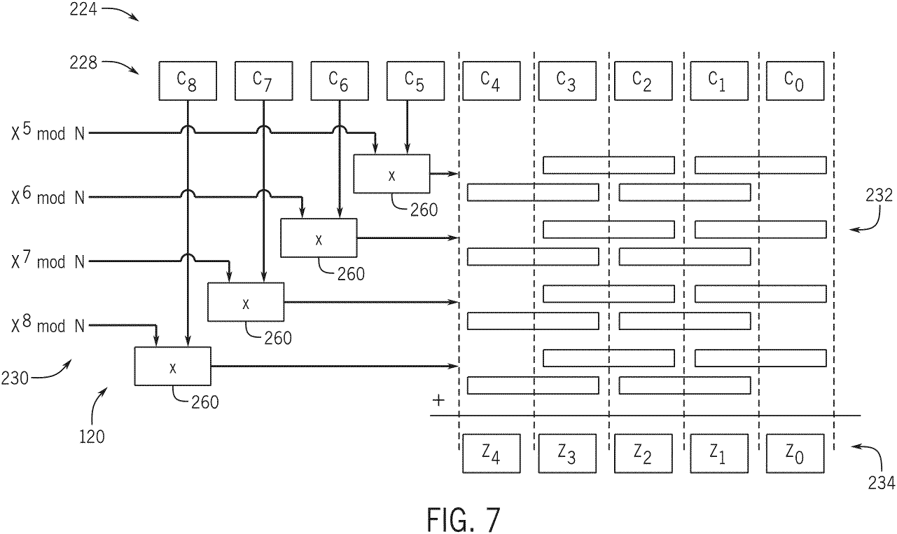

Here, xⁱ mod N is a constant. It could be precomputed. Then Mi is calculated by simply multiplying Cᵢ by that constant. That could be done by using a layer of DSP blocks 120, as shown in FIG. 7. FIG. 7 is a is a schematic diagram using digital signal processing (DSP) blocks 120 to perform multiplication 260 for the modulo N operation 230 for performing polynomial modular reduction 224. The results 232 of the modulo N operation 230 are added to obtain the resulting modular reduction result 234. Note that Mi is now w bits wider than N. To account for that, we may increase polynomial degree d by 1.

### Iterative Multiplicative Reduction Circuit

### A. Iterative Modular Multiplication

Many blockchain and cryptographic applications, such as those providing the impetus for CSAIL2019, may use a larger value N than many VDF problems addressed in prior works. A fully parallel N-bit modular square operation for CSAIL2019 does not fit into even the biggest FPGAs available today.

An iterative approach saves FPGA area, but it also increases latency, and therefore could reduce overall design performance. A straightforward iterative modular multiplication mapping uses an iterative multiplication block followed by an iterative modular reduction block. The overall operation latency is therefore a sum of the multiplication latency and the modular reduction latency.

Instead, an improved iterative modular multiplication method has been developed where the iterative multiplication and the iterative modular reduction work in parallel. This is made possible by performing polynomial multiplication starting with most significant words — in effect, performing polynomial multiplication from left to right.

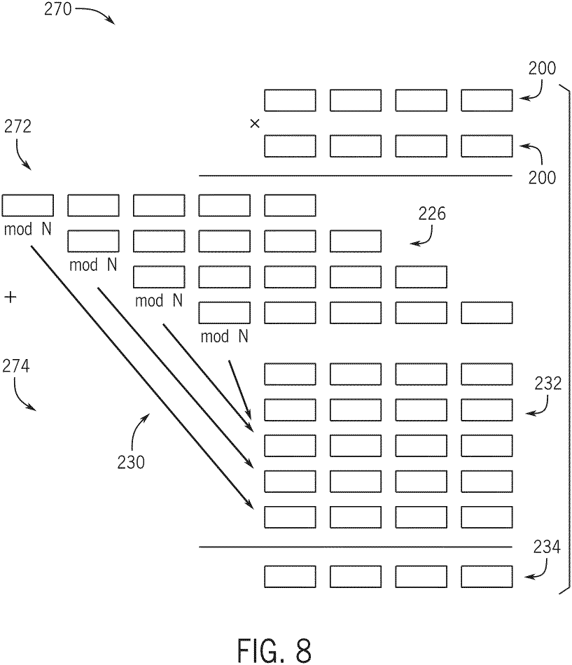

An example overview of a modular multiplication 270 is shown in FIG. 8. The modular multiplication 270 includes polynomial multiplication 272 and modular reduction 274. In contrast to prior methods, however, the modular reduction 274 may operate in parallel with the polynomial multiplication 272, beginning shortly after the polynomial multiplication 272 has calculated a first set of partial products 226.

In the modular multiplication 270 of FIG. 8, two polynomials 200 may be multiplied starting with most significant words, meaning that the first set of partial products 226 that are obtained can quickly be used in modulo N operations 230 in parallel while subsequent partial products 226 are being calculated. What is more, the results 232 of the modulo N operations 230 may also begin to be accumulated so that the modular reduction 234 may be obtained very quickly after the last set of partial products 226 are obtained in the polynomial multiplication 272.

Indeed, the first iteration of modular reduction 224 may start immediately after the first iteration of the polynomial multiplication 272. Consequently, the overall modular multiplication 270 operation latency is only slightly greater than the latency of a regular, non-modular multiplication.

The method may be summarized below:

ALGORITHM 1: Iterative Multiplication mod N

| | |
|---|---|
| 1: | Input: A = {Aₙ₋₁, ..., A₀} |
| 2: | Input: B = {Bₙ₋₁, ..., B₀} |
| 3: | Output: Z = {Zₙ₋₁, ..., Z₀} |
| 4: | Variable: M = {Mₙ₋₁, ..., M₀} = 0 |
| 5: | Variable: S = {Sₙ₋₁, ..., S₀} = 0 |
| 6: | Variable: P = {Pₙ, ..., P₀} |
| 7: | for i from n - 1 to 0 do |
| 8: | P = A ∗ Bᵢ + (M << W) |
| 9: | M = {Pₙ₋₁, ..., P₀} |
| 10: | S = S + (Pₙ ∗ 2^{i∗W/n}) mod N |
| 11: | end for |
| 12: | Z = S + (M mod N); |

Here, W-bit inputs A and B are subdivided into n limbs (e.g., bytes, words). On every iteration (loop index i is decremented from n-1 down to 0), A is multiplied by Bᵢ by a rectangular multiplier to produce an n + 1 limb rectangular product. The lower n limbs of the product are stored in variable M to use in the next iteration. The upper limb of that product (Pₙ) is sent to the multiplier-based modular reduction circuit where it reduced modulo N. The reduced value is then fed into the running accumulator S. Upon completion of the loop, one modular reduction is done in order to reduce M mod N, before constructing the final result Z.

Using this method, A∗B mod N may be calculated in n + 1 latency cycles (e.g., assuming multiplication and reduction each take one cycle) using n times less resources when compared with a fully parallel implementation. The direction of compute is from the most significant bits of B, or from left to right, rather than the classical (pen-and-paper) right-to-left multiplication.

### B. Hardware Architecture and FPGA Mapping

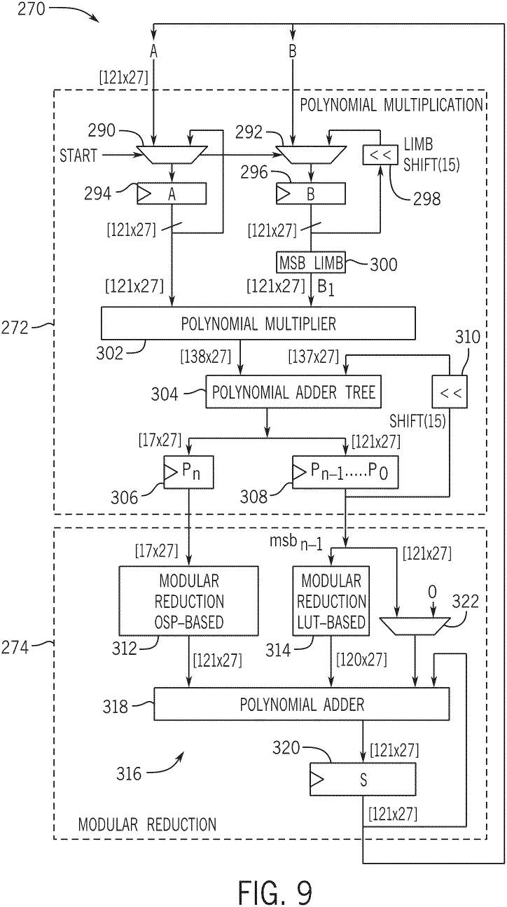

A hardware implementation of the iterative modular multiplier 270 is shown in FIG. 9. It includes two main sub-modules: polynomial multiplication 272 (also referred to as iterative multiplier 272) and modular reduction 274. While a number of specific bit widths are described, it should be understood that these are meant to be explanatory and that any other suitable bit widths may be used. For example, the bit widths may be chosen based on common hardware specifications (e.g., 8-bit memories, 27-bit hardened DSP arithmetic circuitry), and may be adjusted based on the available hardware.

In the example of FIG. 9, the iterative multiplier 272 receives polynomials A and B of degree 120 (121 terms) with x corresponding to 2²⁶ and coefficient radix R=2²⁷ (denoted by [121x27] in FIG. 9) into selection circuitry 290 and 292. This allows for integer inputs of up to 3146 = 26 * 121 bits to be represented. This bit-width is sufficient to handle the 3072+32 = 3104-bit N′ (the additional 32 bits are used for the error detection mechanism described further below). Note that due to the redundant polynomial representation (1-bit overlap between consecutive coefficients), the total number of bits used to manipulate the polynomials is 27 * 121 = 3267.

Based on a selection signal Start, the selection circuitry 290 and 292 may provide new input polynomials into registers 294 and 296, respectively, or may maintain the polynomials A and B. The polynomial B is split into 8 limbs, with each limb having 16 coefficients (most significant limb has only the 9 least significant coefficients populated, with the rest tied to zero). A limb shifter 298 may shift the limbs of the polynomial B so that the most significant bit (MSB) limb 300 is multiplied each iteration.

A polynomial multiplier 302 component multiplies iteratively A by the limbs of B, starting from the most significant one, as previously explained in Algorithm 1. For the first iteration, the product flows through a polynomial adder 304 unaltered and gets split into an upper part Pₙ stored in a first register 306 and a lower part {Pₙ₋₁, ..., P₀} stored in a second register 308, which may be shifted by a shifter 310 (e.g., < < 16) back on the second input of the adder 304, to be summed with the next partial product ABᵢ₋₁.

For each iteration, the high part of the sum Pn is propagated to the modular reduction 274 component. The modular reduction 274 component includes a circuit to perform DSP-based modular reduction 312 and a circuit to perform lookup table (LUT)-based modular reduction 314. The DSP-based modular reduction 312 outputs a 121-coefficient result that is fed into a polynomial accumulator 316 that includes a polynomial adder 318 and an accumulator register 320 that stores an accumulated value S. Selection circuitry 322 may pass either a value of 0 or all but the most significant bit of the most significant limb of {Pₙ₋₁, ..., ₀} into the polynomial adder 318. On the last iteration, all but the most significant bit of the most significant limb of {Pₙ₋₁, ..., P₀} also get added into S. The most significant bit of Pₙ₋₁ is passed through the LUT-based modular reduction 314, and gets added into S as well. The 3120-bit range offered by the 121-coefficient polynomials ensures that at the output of the DSP-based modular reduction 312, no overflow can happen in the most significant coefficient by summing up 17 3104-bit terms. Even considering the 8 iterations involved in performing the full modular multiplication, it would not grow the most significant limb contribution above 3111 bits, which is lower than 3120.

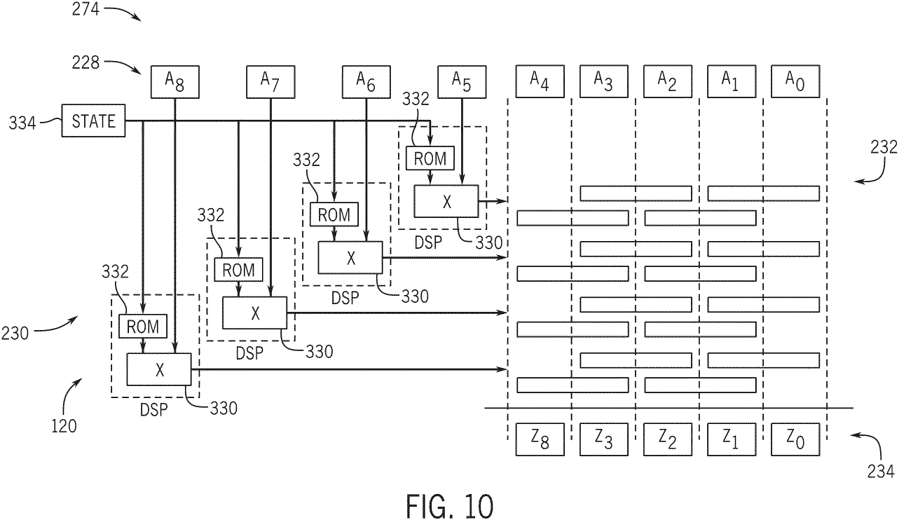

Any suitable modular reduction circuits 312 and 314 may be used. Because the relative weight of the Pₙ term changes with every iteration, the value that is to be reduced consequently changes. There is a similar challenge for multiplicative reduction in that every iteration involves a different constant. Yet here, the cost of tabulation may be much less and, in some cases, may be absorbed by the FPGA DSP blocks 120 themselves. One example is shown in FIG. 10. Modulo N operations 230 may be performed using multiplicative modular reduction by way of multipliers 330 from DSP blocks 120. Memories (ROMs) 332 may store lookup table entries that are used in the multiplicative modular reduction, indexed by a state register 334 that stores the operation read address for the table as the index in that current iteration. Here, the state register 334 contains the current iteration index and is used to select the correct constant from the ROMs 332 for every iteration. In some FPGAs, a built-in coefficient storage (e.g., originally designed to support multichannel finite impulse response (FIR) filters) may be repurposed for the Ci storage. These internal ROMs may be 8 elements deep; as long as the number of iterations per modular multiplication does not exceed 8, the entire coefficient storage may be absorbed into these embedded blocks. Thus, the cost of soft logic for this method may be zero, in contrast to around 1.5 million lookup tables (LUTs) of soft logic elements using a tabular reduction case.

### C. Overclocking with Error Detection

In actual cryptocurrency applications, there is a race to finish first. Calculation speed (over many billions of calculations) has an outsized effect on how quickly results are obtained. Overclocking, however, can introduce errors. To account for this, the iterative multiplicative reduction circuit of this disclosure may be overclocked without long-term problems due to a very fast method for checking the value of intermediate results.

Consider an example in which the circuit is overclocked by 10%, making the calculations from the circuit 10% faster, but causing the circuit to throw up an error every 1,000,000 calculations. This means (since the circuit is being operated iteratively) that all following calculations will be wrong (e.g., the desired answer is after the billions of iterations). But if the correctness is calculated offline (e.g., using a processor running in the FPGA such as a Nios processor, using a processor running apart from the FPGA, using a separate computing system such as the host 18 of FIG. 1) and it takes the equivalent of 10,000 iterations to do this because it is running relatively slowly, and it finds that there is an error, there is a fix that does not add much latency. When an error check is started, the output of the circuit may be timestamped to when the error check started and saved. Thus, the output at the present error check may be timestamped and stored. Likewise, the output at the previous error check may have been previously stored. If an error is found during the present error check, the present run may be stopped and the last correct output may be introduced to the circuit, the iteration counter may be backed up, and calculations may start up again.

Returning to the example where the overclock is 10% and backups occur 2×10,000 iterations every 1,000,000 clock cycles. In so doing, iteration performance is reduced by 2%, but throughput is increased by 10%, which means the circuit is still 8% faster overall. In an actual implementation, the iterative multiplicative reduction circuit may be overclocked even more (e.g., by 20% or more in some cases).

For very long-running computations it is very useful to be able to detect errors early on. If an error goes undetected then all computations performed after the error, which may be many years of computations, would be useless. On the other hand, with an error detection mechanism in place, the hardware can be safely overclocked — run using a clock frequency larger than what is reported by the design software (e.g., the Timing Analyzer of the Quartus software by Intel Corporation) — and rely on an error detection mechanism to catch errors caused by overclocking. In the unlikely event of an error, the system may be able to simply revert to a checkpoint state as a starting point. When the checkpoint state is saved every few minutes, if an error is detected, the system may revert to a starting point only several minutes old. This is insignificant in the case of what can be multi-month or multi-years runs.

Numerous approaches may be used to detect an error. In one example, the following approach may be used: instead of doing calculations modulo N, calculations modulo N′=NP may be performed, where P = 4294963787 is a 32-bit prime that produces the longest possible cycle L = (P - 3)/2 = 2147481892. Conversion of a value modulo N′ to a value modulo N involves taking the remainder modulo N of that value. Thus, operating mod N′ provides a way to check for errors in the calculations at any moment in time. The process involves comparing the result modulo P with the expected value as shown below. Note that K in Algorithm 2 represents the total number of modular multiplications (squarings) done so far.

ALGORITHM 2: Error detection

| | |
|---|---|
| 1: | Const: P // generates maximum cycle |
| 2: | Const: L = (P - 3)/2 // P cycle length |
| 3: | Input: X II Current result modulo N · P |
| 4: | Input: K // Current index |
| 5: | Variable: X′ = X mod P |
| 6: | Variable: K′ = (K mod L) + L |
| 7: | Variable: T = 2 |
| 8: | for i from 1 to K′ do |
| 9: | T = (T²) mod P |
| 10: | end for |
| 11: | Return T == X′;< |

Running the error detection algorithm takes just a couple of seconds on a CPU. A probability of an undetected error is 1/2147481892, which is extremely small.

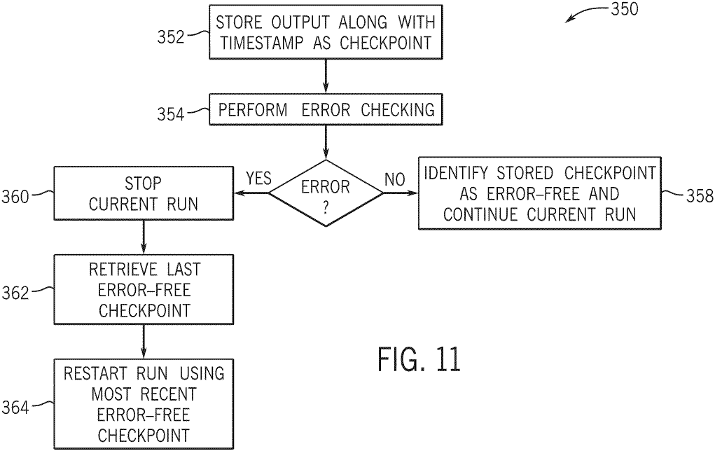

FIG. 11 is a flowchart 350 of an example method using error detection to operate for an extended period of time (e.g., days, months, or years) with confidence in the ultimate result. The method of FIG. 11 may be performed with or without overclocking. The flowchart 350 may take place on occasion according to any suitable cadence (e.g., periodically after a certain amount of time, periodically after a certain number of iterations, according to a predefined or dynamic error-checking schedule). At block 352, the current output of the circuit may be stored as a checkpoint having a timestamp indicating the current index (e.g., the total number of modular multiplications (squarings) done so far). The checkpoint may be stored locally (e.g., on the FPGA, in volatile or non-volatile memory in the same package or location) or remotely (e.g., in memory of a separate computer system such as the host 18 of FIG. 1, in memory of a cloud computing system). At block 354, error checking may be performed by any suitable error-checking circuitry. For example, this may be done using a processor programmed with software to carry out Algorithm 2 or may be implemented in programmable logic circuitry to carry out Algorithm 2. In this way, the error checking of block 354 may be performed locally on the FPGA or offline in a separate computer system.

If there is no error (decision block 356), the calculations may continue to run and/or the stored checkpoint may be identified as error-free (block 358). If there is an error (decision block 356), however, the current run may be stopped (block 360), the most recent error-free checkpoint (e.g., the previous checkpoint) may be retrieved (block 362), and the run may be restarted using the values (e.g., output, index) from the most recent error-free checkpoint (block 364).

### Directed Pipelining

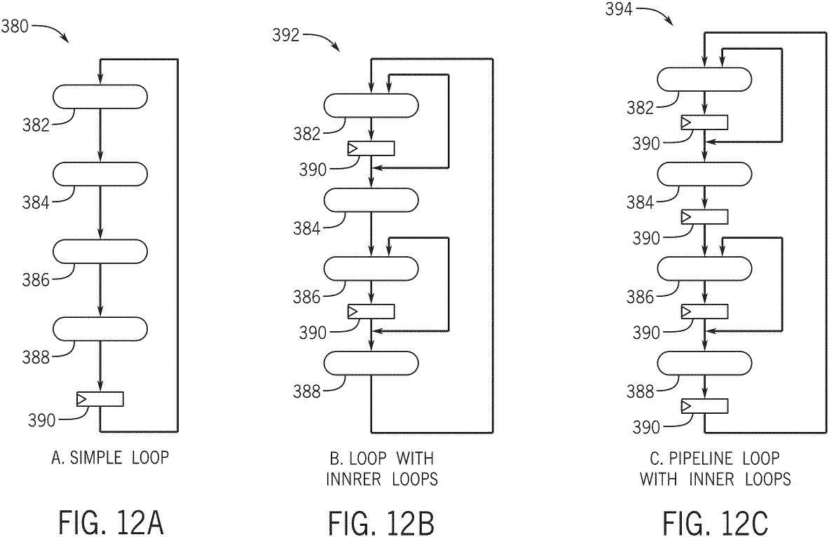

Recent designs for large modular multiplication contain a datapath organized as a “simple loop” as shown on FIG. 12A, which is a schematic diagram 380 of iterative logic circuitry 382, 384, 386, and 388 organized as a simple loop clocked to a register 390. Adding additional latency stages into a simple loop architecture such as the one shown in FIG. 12A does not improve the overall speed of computations. Even though the additional pipeline stage allows the computations to run at a higher clock frequency, the tradeoff is that it also increases the number of clock cycles to go through the loop, reducing the overall performance. This tradeoff may be seen in many recent designs, which may use just 1 or 2 clock cycles per iteration, and therefore contain very deep unpipelined datapaths with very slow clock frequencies (e.g., 20-40 MHz). If those designs are pipelined slightly deeper, the clock frequency increases, but performance remains almost perfectly offset by the increased number of cycles per iteration (e.g., with an iteration rate of 40 MHz).

An improved way to introduce pipelining into a very deep combinatorial design for FPGA may use inner loops. Indeed, the iterative multiplicative reduction circuit 270 shown in FIG. 9 is organized as 2-level loop with inner loops. A schematic diagram 392 of FIG. 12B shows a schematic structure of a 2-level loop with inner loops. The schematic diagram 392 of FIG. 12B shows a main loop operating according to a main loop clock frequency applied to the last register 390 and two inner loops formed around the logic circuitry 382 and 386, respectively, using registers 390 clocked to a higher inner-loop frequency. Because the design of FIG. 12B is organized as a nested two-level loop structure, both inner loops may iterate multiple times (e.g., 2 times, 3 times, 4 times, 6 times, 8 times, 12 times, 16 times, 24 times) (synchronously) to produce a modular multiplication result while the outer loop iterates over the modular multiplication some number of times (e.g., t=2⁵⁶ times) to complete the modular exponentiation. The total time to finalize the modular exponentiation therefore equals the time to complete one modular multiplication T multiplied by the number of iteration times to complete the modular multiplication (e.g., 2⁵⁶T₎.

For example, denote by X the inner loop iteration count (e.g., the execution stays in the inner loop for X=8 clock cycles), while completing one iteration of the outer loop takes an additional Y iterations. The total number of clock cycles per iteration is therefore X+Y. Adding an extra pipeline stage into the outer loop (Y➔Y+1) increases the total number of clock cycles per iteration by 1 (X+Y➔X+Y+1). The relative increase in clock cycles required to compute one modular multiplication (e.g., outer loop) can be expressed as C1=(X+Y+1)/(X+Y). Adding an additional pipeline stage in the outer loop using an additional register 390, as shown by a schematic diagram 394 of FIG. 12C, would decrease the maximum logic depth by a coefficient C2=(Y+1)/Y (assuming that the pipeline stages are distributed evenly). Since C1<C2, the overall design performance will increase if the logic circuitry depth in the inner loop is smaller than the outer loop logic depth. Therefore, the overall performance can be improved by adding pipeline stages into an outer loop until the outer loop maximum logic depths matches the inner loop logic depth.

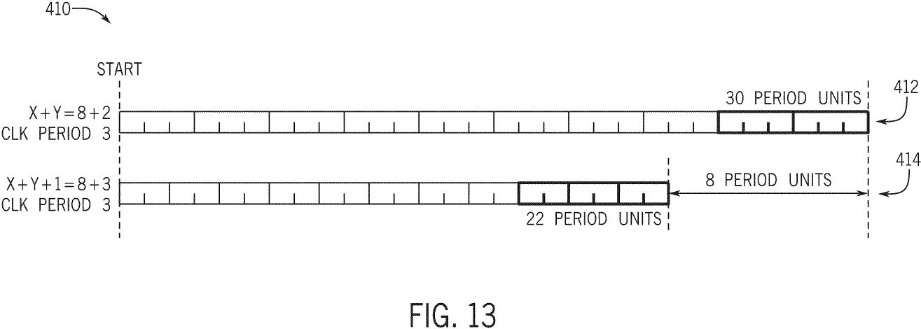

FIG. 13 shows an example timing diagram 410 for X = 8 when the pipeline depth of the outer loop is Y=2 (plot 412) and when the pipeline depth of the outer loop is Y=3 (plot 414). By increasing the pipeline depth of the outer loop from Y=2 to Y=3, the critical path delay (e.g., which may be assumed to be in the outer loop) has decreased by one third, from 3 period units in plot 412 to 2 period units in plot 414. Consequently, the total delay of the deeper pipelined design of plot 414 has decreased from 30 to 22 period units, a savings of 8 period units.

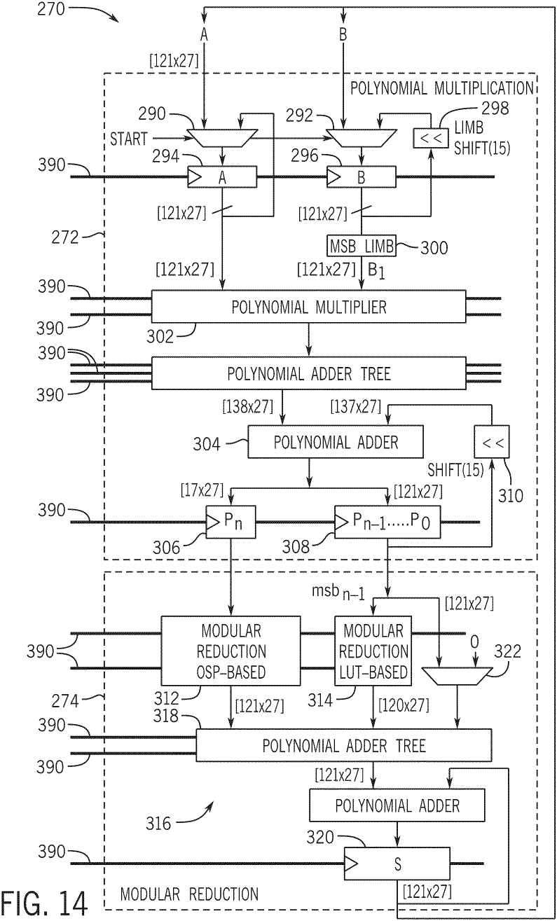

This approach may be applied to the two-level loop datapath of the iterative multiplicative reduction circuit 270, as shown in FIG. 14. Formed by adding additional registers 390 to the circuit of FIG. 9 to add additional pipeline stages, FIG. 14 illustrates a pipelined iterative multiplicative reduction circuit 420. A total of 9 additional pipeline stages were added to the outer loop, bringing the overall number of pipelines to 12. Since the accumulation loops (e.g., inner loops) run for 8 cycles, the overall number of clock cycles per iteration (e.g., of the outer loop) is 12+8-1 =19. The maximum logic depth of the pipelined design corresponds to 2 consecutive adders which is the minimum possible depth of the accumulation loop.

### A. Implementation

A CSAIL solver using the pipelined iterative multiplicative reduction circuit of FIG. 14 was implanted using an INTEL AGILEX® F-Series FPGA Development Kit based on AGFB014R24A2E3VR0 FPGA device, as this was a recent FPGA available use in development board form. This is a mid-size Agilex device and therefore motivates development of an area-efficient solution. In terms of frequency, it is believed that switching to a faster-speedgrade device can improve frequency further (e.g., an additional 20%). Although this device has less than half the logic of some other available devices, the DSP-based circuit presented in this disclosure is very logic efficient, as programmable logic may not be required for the coefficient storage. The number of DSP resources of the selected Agilex device is also much lower than many other available devices, but the Agilex DSP blocks can support 27x27 multipliers directly, which is 50% more arithmetically dense than individual DSP blocks of many other available devices.

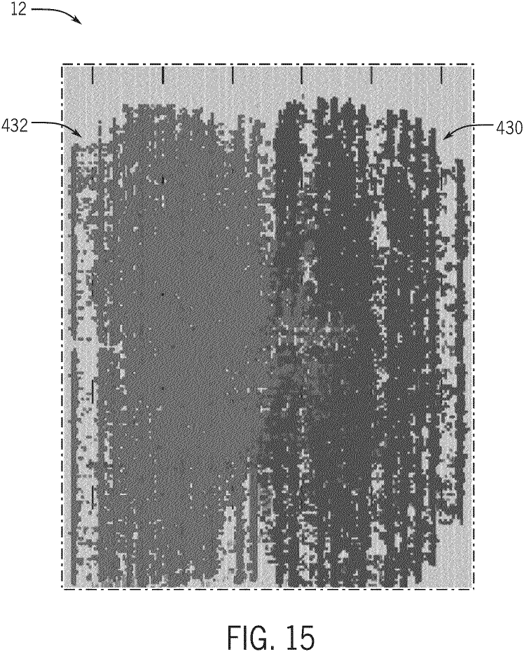

One goal in implementing this circuit is to create a regularly placed design. In one example, this was achieved by a combination of explicit (e.g., placing DSP blocks in columnar groups) and implicit (e.g., the directed pipelining method introduced in the earlier section) methods. An example floorplan implanting the pipelined iterative multiplicative reduction circuit of FIG. 14 onto the integrated circuit system 12 is shown in FIG. 15. The floorplan shown in FIG. 15 was generated without emphasizing logic floorplanning, but rather letting the DSP placement drive the place and route of the solver. A first area 430 represents a portion of resources devoted to the multiplication portion of the circuit and a second area 432 represents a portion of resources devoted to the modular reduction portion of the circuit. Table 2 below illustrates the resources used in this implementation.

TABLE 1

Resource Report

| Hierarchy | ALM | ALM (%) | DSP | DSPs (%) |
|---|---|---|---|---|
| Solver | 161269 | 33 | 3891 | 86 |
| Multiplication | 72256 | 15 | 1936 | 43 |
| Reduction | 82240 | 18 | 1955 | 43 |

In addition to the resources shown in the table, there are also an additional 6573 ALMs and 14 M20K memory blocks used to construct the entire iterative modular implementation. The presented architecture used a 350 MHz clock. As can be observed from Table 2, the proposed circuit balances the resources between the multiplication and reduction components well (e.g., both arithmetic logic units (ALMs) and digital signal processing (DSP) bocks). In addition, the circuit is highly energy efficient. Indeed, this approach has significantly more arithmetic efficiency (e.g., normalized latency) of the next nearest known method and much more energy efficiency.

### Results

The solver started running in February 2022, and found 21 milestone solutions (from t = 2²⁸ to t = 2⁴⁸) in the first 6 months.

The solver is using 350 MHz clock. One squaring operation takes 19 clock cycles, which gives 54 nanoseconds per squaring operation. The actual run times and estimated run times for future solutions is given in Table 3.

TABLE 2

Solver Milestone Status

| | | |
|---|---|---|
| Milestone | Runtime | Status |
| t = 2²⁸ | 13.78 s | Done |
| t = 2²⁹ | 27.56 s | Done |
| t = 2³⁰ | 55.13 s | Done |
| t = 2³¹ | 1.83 m | Done |
| t = 2³² | 3.67 m | Done |
| t = 2³³ | 7.35 m | Done |
| t = 2³⁴ | 14.70 m | Done |
| t = 2³⁵ | 29.70 m | Done |
| t = 2³⁶ | 58.81 m | Done |
| t = 2³⁷ | 1.96h | Done |
| t = 2³⁸ | 3.92h | Done |
| t = 2³⁹ | 7.84h | Done |
| t = 2⁴⁰ | 15.68h | Done |
| t = 2⁴¹ | 1.30d | Done |
| t = 2⁴² | 2.61d | Done |
| t = 2⁴³ | 5.22d | Done |
| t = 2⁴⁴ | 10.45d | Done |
| t = 2⁴⁵ | 20.91d | Done |
| t = 2⁴⁶ | 41.82d | Done |
| t = 2⁴⁷ | 83.64d | Done |
| t = 2⁴⁸ | 167.29d | Done |
| t = 2⁴⁹ | est. 334.58d | In progress |
| t = 2⁵⁰ | est. 1.83y | not started |
| t = 2⁵¹ | est. 3.66y | not started |
| t = 2⁵² | est. 7.32y | not started |
| t = 2⁵³ | est. 14.65y | not started |
| t = 2⁵⁴ | est. 29.31y | not started |
| t = 2⁵⁵ | est. 58.62y | not started |
| t = 2⁵⁶ | est. 117.25y | not started |

These results were reported to the MIT CSAIL team and confirmed as correct.

To achieve even higher performance results, the current iteration time may be reduced. Indeed, while the example architecture that has been implemented uses an 8-cycle iteration, which is driven by the number of resources (e.g., the 4150 DSP Blocks) on the mid-size device mentioned above, larger FPGAs may be used, with over 12 K DSP Blocks on some of the larger devices.

Several variations may significantly improve these current results. Using a device with more DSP blocks (e.g., an FPGA with twice the number of DSP Blocks) may enable doubling the throughput. In fact, the same FPGA family used to achieve the results above also has members with 3x the DSP Blocks. Although this would not evenly divide into the iteration granularity, a mixed (e.g., multiplicative and table based) approach may be employed. As both types of reduction calculations remap portions of values that are outside the N width modulus width back into that space, they will be compatible with each other. A relatively small amount of soft logic is being used compared to the amount of DSP circuitry, so a reasonably routable solution may be realized. One caveat is that reducing the number of iterations may increase the critical path, especially in the summation of the partial product columns (e.g., including both the multiplication and reduction portions of the implementation), which may impact the operating frequency negatively.

Moreover, the FPGA may be overclocked to achieve even faster results. For example, the FPGA may be overclocked by 10%. With a low logic use, and almost no memory blocks in the design, the power consumption is lower than typical for a full chip design of this size. As such, this is not near the thermal limits of this device. Moreover, there is a robust error checking method to continuously verify our results. There are several different possibilities to further develop overclocking: both tuning the methods of this disclosure as well as others. For example, the operating frequency may be boosted by 25% over the reported value by monitoring power (which may increase with increased frequency, thereby increasing temperature, and in turn reducing the thermal margin). The power-based performance improvement may be a slowly varying parameter. The continued correct operation of the circuit can be monitored by the error checking methodology explained earlier in this disclosure.

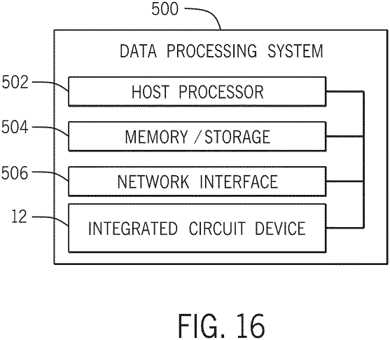

The circuit discussed above may be implemented on the integrated circuit system 12, which may be a component included in a data processing system, such as a data processing system 500, shown in FIG. 16. The data processing system 500 may include the integrated circuit system 12 (e.g., a programmable logic device), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 16 may include the integrated circuit system 12 with the programmable routing bridge 84. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit system 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the programmable routing bridge described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]...” or “step for [perform]ing [a function]...”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. Circuitry comprising:
polynomial multiplication circuitry to multiply a first input value to a second input value to compute a result; and
modular reduction circuitry to perform modular reduction on multiplicative components of the result independently while other multiplicative expansion components of the result are still be calculated by the polynomial multiplication circuitry.

EXAMPLE EMBODIMENT 2. The circuitry of example embodiment 1, wherein the first input value and the second input value comprise a plurality of limbs, and wherein the polynomial multiplication circuitry multiplies the first input value to the second input value from a most significant limb to a least significant limb.

EXAMPLE EMBODIMENT 3. The circuitry of example embodiment 2, wherein the polynomial multiplication circuitry generates the first component of the product as a partial product corresponding to multiplying the most significant limb of the first input value to the most significant limb of the second input value.

EXAMPLE EMBODIMENT 4. The circuitry of example embodiment 1, wherein the circuitry is implemented in programmable logic and digital signal processing (DSP) blocks of a field programmable gate array (FPGA).

EXAMPLE EMBODIMENT 5. The circuitry of example embodiment 1, wherein the modular reduction circuitry performs modular reduction by multiplicative modular reduction to generate a modular reduction result that is a sum of multiple individual multiplicative reduction results.

EXAMPLE EMBODIMENT 6. The circuitry of example embodiment 5, wherein the modular reduction circuitry comprises a lookup table having entries that are used in the multiplicative modular reduction.

EXAMPLE EMBODIMENT 7. The circuitry of example embodiment 6, comprising a state register that stores an operation read address for the lookup table as an index in a current iteration.

EXAMPLE EMBODIMENT 8. The circuitry of example embodiment 7, wherein the state register comprises an embedded memory of a digital signal processing (DSP) block of field programmable gate array (FPGA) circuitry.

EXAMPLE EMBODIMENT 9. The circuitry of example embodiment 1, comprising clock circuitry to operate at an overclocked frequency.

EXAMPLE EMBODIMENT 10. The circuitry of example embodiment 1, wherein the polynomial multiplication circuitry and the modular reduction circuitry are pipelined with multiple levels of pipelining using a plurality of intermediate registers, wherein different groups of the registers operate on different clocks.

EXAMPLE EMBODIMENT 11. An article of manufacture comprising one or more tangible, non-transitory, machine-readable media storing instructions to program a programmable logic device with a system design comprising:
multiplication circuitry to multiply a first input value to a second input value having a plurality of components in order from most significant component to least significant component to generate a plurality of partial products; and
modular reduction circuitry to perform modular reduction on a first partial product of the plurality of partial products while the multiplication circuitry is still generating other partial products of the plurality of partial products.

EXAMPLE EMBODIMENT 12. The article of manufacture of example embodiment 11, wherein the modular reduction circuitry comprises digital signal processor (DSP)-based modular reduction circuitry and lookup table (LUT)-based modular reduction circuitry.

EXAMPLE EMBODIMENT 13. The article of manufacture of example embodiment 11, wherein the multiplication circuitry and the modular reduction circuitry comprise a plurality of pipeline registers.

EXAMPLE EMBODIMENT 14. A method comprising:
iteratively performing multiplication and modular reduction operations using integrated circuitry over a plurality of iterations;
after a first of the plurality of iterations has completed, storing a first output of the first of the plurality of iterations;
performing error checking on the first output;
determining that the first output is not erroneous;
after a second of the plurality of iterations has completed, storing a second output of the second of the plurality of iterations;
performing error checking on the second output;
determining that the second output is erroneous;
retrieving the first output; and
ignoring operations performed between the first output and the second output and iteratively performing the multiplication and modular reduction operations at an iteration based on the first output.

EXAMPLE EMBODIMENT 15. The method of example embodiment 14, wherein iteratively performing multiplication and modular reduction operations is carried out using a first integrated circuit and the error checking is performed using a different integrated circuit.

EXAMPLE EMBODIMENT 16. The method of example embodiment 14, wherein the second of the plurality of iterations occurs multiple iterations after the first of the plurality of iterations and wherein the error checking is performed at a lower clock speed than the multiplication and modular reduction operations.

EXAMPLE EMBODIMENT 17. The method of example embodiment 14, wherein iteratively performing multiplication and modular reduction operations is carried out using the integrated circuitry, wherein the integrated circuitry is overclocked.

EXAMPLE EMBODIMENT 18. The method of example embodiment 14, wherein the error checking is performed not on modulo N, where N is the current output, but rather on modulo N′=NP, wherein the value modulo N′ is converted to a value modulo N by taking a remainder modulo N of that value and comparing the result modulo P with an expected value.

EXAMPLE EMBODIMENT 19. The method of example embodiment 14, wherein the first output is stored in memory on the integrated circuitry on which the multiplication and modular reduction operations are iteratively performed.

EXAMPLE EMBODIMENT 20. The method of example embodiment 14, wherein the first output is stored in memory of a computing system distinct from the integrated circuitry on which the multiplication and modular reduction operations are iteratively performed.

What is claimed is:

1. Circuitry comprising:
polynomial multiplication circuitry to multiply a first input value to a second input value to compute a result; and
modular reduction circuitry to perform modular reduction on multiplicative components of the result independently while other multiplicative expansion components of the result are still be calculated by the polynomial multiplication circuitry.

2. The circuitry of claim 1, wherein the first input value and the second input value comprise a plurality of limbs, and wherein the polynomial multiplication circuitry multiplies the first input value to the second input value from a most significant limb to a least significant limb.

3. The circuitry of claim 2, wherein the polynomial multiplication circuitry generates the first component of the product as a partial product corresponding to multiplying the most significant limb of the first input value to the most significant limb of the second input value.

4. The circuitry of claim 1, wherein the circuitry is implemented in programmable logic and digital signal processing (DSP) blocks of a field programmable gate array (FPGA).

5. The circuitry of claim 1, wherein the modular reduction circuitry performs modular reduction by multiplicative modular reduction to generate a modular reduction result that is a sum of multiple individual multiplicative reduction results.

6. The circuitry of claim 5, wherein the modular reduction circuitry comprises a lookup table having entries that are used in the multiplicative modular reduction.

7. The circuitry of claim 6, comprising a state register that stores an operation read address for the lookup table as an index in a current iteration.

8. The circuitry of claim 7, wherein the state register comprises an embedded memory of a digital signal processing (DSP) block of field programmable gate array (FPGA) circuitry.

9. The circuitry of claim 1, comprising clock circuitry to operate at an overclocked frequency.

10. The circuitry of claim 1, wherein the polynomial multiplication circuitry and the modular reduction circuitry are pipelined with multiple levels of pipelining using a plurality of intermediate registers, wherein different groups of the registers operate on different clocks.

11. An article of manufacture comprising one or more tangible, non-transitory, machine-readable media storing instructions to program a programmable logic device with a system design comprising:
multiplication circuitry to multiply a first input value to a second input value having a plurality of components in order from most significant component to least significant component to generate a plurality of partial products; and
modular reduction circuitry to perform modular reduction on a first partial product of the plurality of partial products while the multiplication circuitry is still generating other partial products of the plurality of partial products.

12. The article of manufacture of claim 11, wherein the modular reduction circuitry comprises digital signal processor (DSP)-based modular reduction circuitry and lookup table (LUT)-based modular reduction circuitry.

13. The article of manufacture of claim 11, wherein the multiplication circuitry and the modular reduction circuitry comprise a plurality of pipeline registers.

14. A method comprising:
iteratively performing multiplication and modular reduction operations using integrated circuitry over a plurality of iterations;
after a first of the plurality of iterations has completed, storing a first output of the first of the plurality of iterations;
performing error checking on the first output;
determining that the first output is not erroneous;
after a second of the plurality of iterations has completed, storing a second output of the second of the plurality of iterations;
performing error checking on the second output;
determining that the second output is erroneous;
retrieving the first output; and
ignoring operations performed between the first output and the second output and iteratively performing the multiplication and modular reduction operations at an iteration based on the first output.

15. The method of claim 14, wherein iteratively performing multiplication and modular reduction operations is carried out using a first integrated circuit and the error checking is performed using a different integrated circuit.

16. The method of claim 14, wherein the second of the plurality of iterations occurs multiple iterations after the first of the plurality of iterations and wherein the error checking is performed at a lower clock speed than the multiplication and modular reduction operations.

17. The method of claim 14, wherein iteratively performing multiplication and modular reduction operations is carried out using the integrated circuitry, wherein the integrated circuitry is overclocked.

18. The method of claim 14, wherein the error checking is performed not on modulo N, where N is the current output, but rather on modulo N′=NP, wherein the value modulo N′ is converted to a value modulo N by taking a remainder modulo N of that value and comparing the result modulo P with an expected value.

19. The method of claim 14, wherein the first output is stored in memory on the integrated circuitry on which the multiplication and modular reduction operations are iteratively performed.

20. The method of claim 14, wherein the first output is stored in memory of a computing system distinct from the integrated circuitry on which the multiplication and modular reduction operations are iteratively performed.
